(19) United States
(12) Patent Application Publication
(10) Pub. No.: US 2009/0231848 A1
(43) Pub. Date: Sep. 17, 2009

(54) Illuminator module

(76) Inventor: Chiao-En Huang, Keelung (TW)

Correspondence Address: David Shung, P.O. Box 10557, Taipei, 100, TW

(21) Appl. No.: 12/403,507

(22) Filed: Mar. 13, 2009

(30) Foreign Application Priority Data
Mar. 14, 2008 (TW) 097204376

(51) Int. Cl. F21V 21/00

(52) U.S. Cl. 362/249.01

(57) ABSTRACT

The illuminator module is composed of one or more lighting chips, a heat dissipating body and two conductive strips. The heat dissipating body is provided with two positioning grooves for accommodating the conductive strips separately. The heat dissipating body including the positioning grooves is under oxidation treatment to form an insulating layer on its surface. The lighting chips are mounted on the insulating layer. The conductive strips are embedded in the positioning grooves separately. A wire is disposed between the lighting chip and conductive strip for constituting an electric connection. The lighting chips can illuminate when an external power source is connected through the conductive strips.

### BACKGROUND OF THE INVENTION

1. Technical Field

The invention generally relates light emitting devices, more particularly to illuminators using one or more light emitting diode.

2. Related Art

In recent years, light emitting diodes (LEDs) are extensively required by various markets. Manufacturing technologies of the LEDs have been developing. However, the manufactures of the LEDs always tend to increase lighting efficiency but do not make enough effort at applications and processes. As shown in FIG. 1, a conventional LED has a conductive support frame 10, a chip 11 placed in a bowl-shaped carrier 101 of the support frame 10, and an epoxy case 12 for wrapping the support frame 10 and chip 11.

In the procedure of manufacturing LED, the support frame 10 and the expoxy case 12 must be made by a molding process and high temperature forming process, respectively. The molding process of the support frame 10, which includes the various steps of pressing, cutting, polishing and coating, is considerably complicated and uneconomical. It may also cause environment pollution. On the other hand, the expoxy case 12 must consume a long period of time for baking. Thus, it is disadvantageous to mass production.

In real applications, the LEDs are usually arranged in a row or matrix for increasing lighting intensity. For example, a backlight module based on LED disposes a plurality of LEDs on a circuit board in a matrix to form a uniform planar light source.

The single packaged LEDs abovementioned tend to be mislaid. And their exposed support frame 10 is easy to be damaged because of excessive weakness. Furthermore, when arranging the LEDs in a row or matrix, the LEDs must be mounted on a circuit board one by one. It is very disadvantageous for processing.

On the other side, the higher the power of the LEDs is, the more serious the heat from the LEDs is. The LEDs can not normally function if the problem of heat dissipation can not be effectively solved.

### SUMMARY OF THE INVENTION

A primary object of the invention is to provide an independent illuminator module having multiple LEDs, which is easy to be manufactured and can be rapidly processed.

Another object of the invention is to provide an illuminator, which has better heat dissipation effect for satisfying circumstances of high power LEDs.

To accomplish the objects abovementioned, the illuminator according to the invention is composed of one or more lighting chips, a heat dissipating body and two conductive strips. The heat dissipating body is provided with two positioning grooves for accommodating the conductive strips separately. The heat dissipating body including the positioning grooves is under oxidation treatment to form an insulating layer on its surface. The lighting chips are mounted on the insulating layer. The conductive strips are embedded in the positioning grooves separately. A wire is disposed between the lighting chip and conductive strip for constituting an electric connection. The lighting chips can illuminate when an external power source is connected through the conductive strips.

In comparison with the prior art, the illuminator of the invention contains multiple LEDs for supporting applications of high lighting intensity, mixing color or wide-angled lighting. The heat dissipating effect also can be increased by tangible touch between the lighting chips and heat dissipating body.

### BRIEF DESCRIPTION OF THE DRAWINGS

FIG. 1 is a schematic view of a conventional LED;

FIG. 2 is an exploded view of the invention;

FIG. 3 is a sectional view of the illuminator according to the invention;

FIG. 4 is a sectional view of the illuminator with different lighting chip; and

FIG. 5 is a perspective view of another embodiment of the invention.

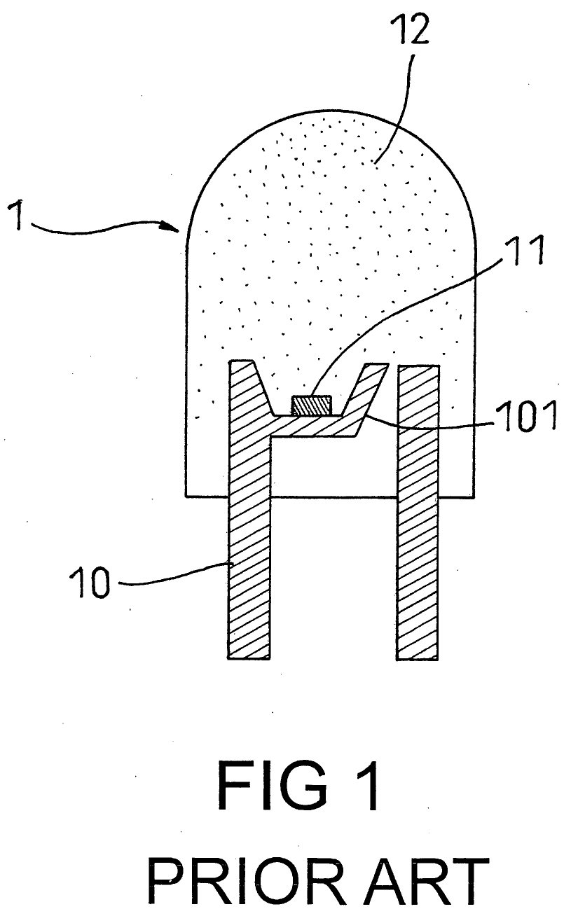

### DETAILED DESCRIPTION OF THE INVENTION

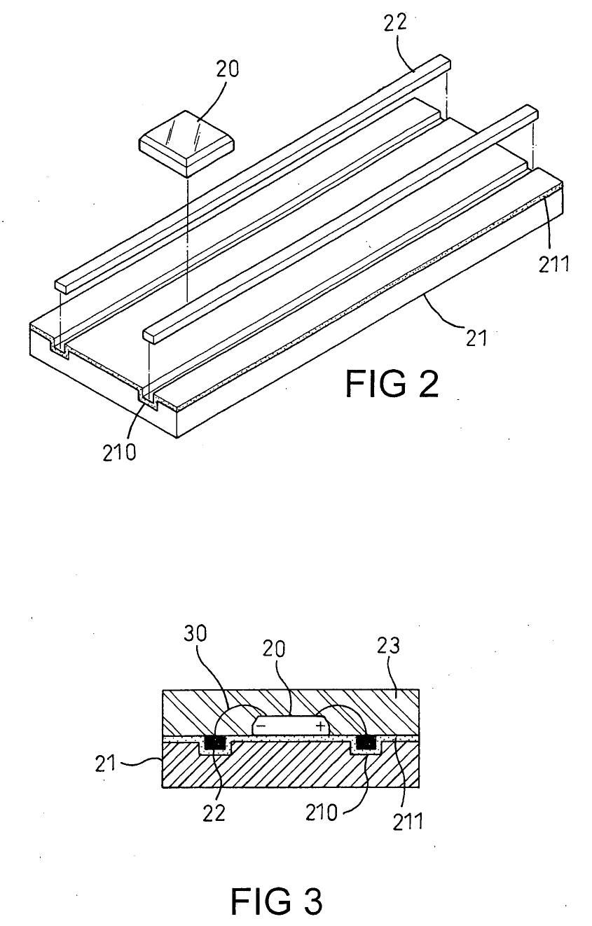

Referring to FIGS. 2-4, an illuminator of the invention is composed of one or more lighting chips 20, a heat dissipating body 21 and two conductive strips 22. The heat dissipating body 21 can be preferably made of aluminum because of its great thermo-conductivity. The conductive strips 22 can be preferably made of copper and can be of a plate shape.

A top side of the heat dissipating body 21 is provided with two positioning grooves 210 for accommodating the conductive strips 22 separately. In process of manufacture, the conductive strips 22 which are corresponding to the positioning grooves 210 in both size and shape are tightly embedded in the positioning grooves 210.

An insulating layer 211 having a predetermined thickness is coated on the surface of the heat dissipating body 21 including the positioning grooves 210 by means of the oxidation treatment. The insulating layer 211 is aluminum oxide (Al₂O₃) when the heat dissipating body 21 is made of aluminum. It is worthy of note that aluminum oxide has a property of high hardness, it is hard to be scratched when the heat dissipating body 21 suffers friction with other objects. Further, the insulating layer 211 formed by aluminum oxide does not tend to deform in a high temperature circumstance. In comparison with conventional epoxy resin, aluminum oxide has better stability. The lighting chip 20 is mounted on the heat dissipating body 21.

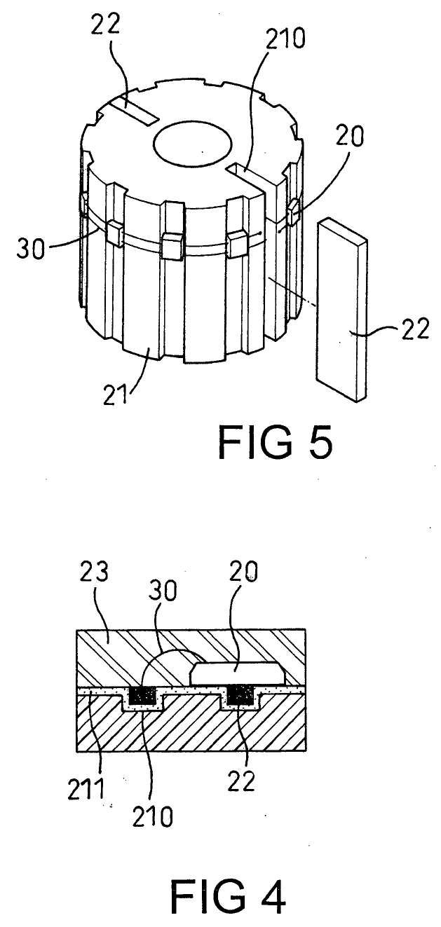

As shown in FIGS. 3 and 4, a wire 30 is provided between an electrode (not shown) of the lighting chip 20 and the conductive strip 22 to constitute an electric connection. A protective layer 23 can further be formed on the heat dissipating body 21 for covering the lighting chip 20 and the wire 30. The lighting chip will light when an external power source is applied through the conductive strips 22.

FIG. 5 illustrates another preferred embodiment of the invention. In this embodiment, the heat dissipating body 20 is of a cylindrical shape. The lighting chips 20 are distributed over the surface of the cylindrical heat dissipating body 21. By connection via wires 30, the lighting chips 20 can electrically connect to the conductive strips 22 in the positioning grooves 210. Such a type of illuminator can be a lamp core of lighting devices for functioning as an annular or cylindrical light source.

In comparison with the prior art, the illuminator of the invention contains multiple LEDs for supporting applications of high lighting intensity, mixing color or wide-angled lighting. The heat dissipating effect also can be increased by tangible touch between the lighting chips 20 and heat dissipating body 21.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. An illuminator module comprising:
at least one lighting chip;
a heat dissipating body being mounted by the at least one lighting chip, being provided with two positioning grooves on a side thereof, and the side being coated with an insulating layer of a metal oxide by oxidation treatment;
two conductive strips embedded in the positioning grooves separately; and
two wires connecting two electrodes of the at least one lighting chip and the conductive strips separately.

2. The illuminator module of claim 1, wherein the heat dissipating body is made of aluminum, and the conductive strips are made of copper.

3. The illuminator module of claim 1, wherein the conductive strips are corresponding to the positioning grooves in both size and shape.

4. The illuminator module of claim 2, wherein the insulating layer is aluminum oxide.

5. The illuminator module of claim 1, wherein the heat dissipating body is a cuboid.

6. The illuminator module of claim 1, wherein the heat dissipating body is a cylinder.
